(19) United States
(12) Patent Application Publication
(10) Pub. No.: US 2019/0364866 A1
(43) Pub. Date: Dec. 5, 2019

(54) FISHING ROD HOLDER FOR STAND-UP PADDLING

(71) Applicant: Matthew Justin Murphy, Houston, TX (US)

(72) Inventor: Matthew Justin Murphy, Houston, TX (US)

(21) Appl. No.: 16/431,044

(22) Filed: Jun. 4, 2019

Related U.S. Application Data
(60) Provisional application No. 62/680,342, filed on Jun. 4, 2018.

(51) Int. Cl. A01K 97/10; F16B 1/00

(52) U.S. Cl. CPC A01K 97/10; F16B 2001/0028; F16B 1/00

(57) ABSTRACT

A fishing rod holder for stand-up paddling permits access to the fishing rod while standing, without the use of an elevated stand or structure onboard the watercraft. Having a small and compact design facilitates easy storage (e.g. Tackle box) and could be installed, adjusted or re-positioned while onboard the watercraft only where and when it is needed. The device is non-destructively attached to the paddle or push-pole and can be adjusted, removed or transferred to alternate paddles or push-poles without the use of tools and secures the fishing rod from falling overboard at any orientation even when upside-down. By removably and non-destructively attaching the fishing rod to the paddle, there is no damage to the watercraft, which maintains its watertight integrity. The removability permits easy transfer to other types of watercraft or paddling devices.

### CROSS-REFERENCE TO RELATED APPLICATION

This application claims the benefit of priority of U.S. provisional application No. 62/680,342, filed Jun. 4, 2018, the contents of which are herein incorporated by reference.

### BACKGROUND OF THE INVENTION

The present invention relates to fishing rods, and more particularly to holders to secure a fishing rod to a paddle.

To operate a self-propelled watercraft such as a Stand Up paddleboard (SUP), kayak, canoe, rowboat, push boat or similar, using a paddle or push-pole typically requires the use of both hands. These self-propelled watercraft have limited space and mobility onboard and are greatly influenced by environmental conditions such as wind, waves and current. These circumstances cause several problems.

Operating these types of watercraft requires both hands creating the problem of securing the fishing rod from falling overboard, as well as retrieving the fishing rod after it has fallen into the water. Having limited space and mobility creates the problem of accessibility to the fishing rod while standing and any movement onboard required to access the fishing rod creates watercraft instability.

The influence of the environment creates the problem of maintaining position or heading control while fishing; this problem can be exacerbated by the amount of time required to switch between fishing and paddling mode to return watercraft position and heading control.

Another problem exists in the method of attaching or installing fishing rod holder(s) without causing permanent damage to the watercraft, paddle or push-pole through the use of adhesives (glue, tape, epoxy, resins) or those that require the drilling or cutting of holes and/or the use of hardware (bolts, screws) to securely anchor the fishing rod holder to the watercraft, paddle or push-pole.

Another problem with these attachment methods are that they require the use of tools and or special know-how to install, adjust or re-positioned the fishing rod holder(s).

Typical fishing rod holder(s) are installed onboard the watercraft in a fixed location by drilling or cutting holes combined with adhesives and or hardware to anchor the fishing rod holder causing permanent damage to the watercraft. Using this type of installation, the fishing rod holder cannot be re-positioned or adjusted without the proper tools or know-how. Permanent damage to the watercraft such as holes for hardware jeopardizes its watertight integrity and may reduce its value.

As can be seen, there is a need for an improved fishing rod holder that permits having the fishing rod removably and non-destructively attached on the paddle or push-pole and allows for access while standing without the use of an elevated stand or structure onboard the watercraft. A small and compact design facilitates easy storage (e.g. tackle box) and can readily be installed, adjusted or repositioned while onboard the watercraft only where and when it is needed.

### SUMMARY OF THE INVENTION

In one aspect of the present invention a rod holder for securing a fishing rod to an elongate shaft, is disclosed. The fishing rod holder includes a holding block having a concave surface defined along a longitudinal length of the first holding block and a V shaped notch defined along the longitudinal length of the holding block along a side opposite the concave surface. The concave surface dimensioned to receive at least a portion of the elongate shaft and the V shaped notch dimensioned to receive at least a portion of the fishing rod. A strap slot is defined transversely through the holding block between the concave surface and the V shaped notch. A strap has a first free end and a second end. The strap is formed of a cooperating hook and loop material applied to a front surface and a back surface of the strap. The strap has a transverse dimension to be received through the strap slot. The strap has longitudinal length sufficient to at least extend through the strap slot, a first wrap around a first end of the holding block having the concave surface, and overlap at least a portion of the second end and the elongate shaft when received in the concave surface.

Preferably, the longitudinal length of the strap is sufficient to wrap around the side opposite the concave surface, the rod when received in the V shaped notch, and overlap at least a portion of the first wrap.

In some embodiments, a strap loop is attached to the second end of the strap. The strap loop is dimensioned to receive the strap through the strap loop in the first wrap.

In some embodiments, the rod holder includes a second holding block having a concave surface defined along a longitudinal length of the second holding block. A V shaped notch is defined along the longitudinal length of the second holding block along a side opposite the concave surface. The concave surface is dimensioned to receive at least a portion of the elongate shaft. The V shaped notch dimensioned to receive at least a portion of the rod. A second strap slot is defined transversely through the second holding block between the concave surface and the V shaped notch. A second strap has a first free end and a second end. The second strap is formed of a cooperating hook and loop material applied to a front surface and a back surface of the second strap. The second strap has a transverse dimension to be received through the second strap slot and a longitudinal length sufficient to at least extend through the second strap slot, a first wrap around a first end of the second holding block having the concave surface and overlap at least a portion of the second end of the second strap and the elongate shaft, when received in the concave surface of the second holding block.

In some embodiments, the longitudinal length of the second strap is sufficient to wrap around the side opposite the concave surface of the second block, the rod when received in the V shaped notch of the second block, and overlap at least a portion of the first wrap about the second holding block.

In some embodiments, a strap loop is attached to the second end of the second strap, the strap loop dimensioned to receive the second strap through the strap loop when the strap on the first wrap about the second holding block.

In some embodiments, a separation between the concave surface of the second holding block and the V shaped notch of the second holding block is less than a separation between the concave surface of the first holding block and the V shaped notch of the first holding block.

In other embodiments, a width and a depth of the V shaped notch of the second holding block is greater than a width and a depth of the V shaped notch of the first holding block.

In other aspects of the invention, a fishing rod holder for securing the fishing rod to an elongate shaft of a paddle for a watercraft is disclosed. The fishing rod holder includes a first block having a concave surface defined along a longitudinal length of the first block, the concave surface dimensioned to abut a longitudinal length of the elongate shaft. A notch is defined along the longitudinal length of the first block opposite the concave surface. The notch dimensioned to receive a longitudinal length at a first segment of the fishing rod. A second block has a concave surface defined along a longitudinal length of the second block. The concave surface is dimensioned to abut a longitudinal length of the elongate shaft. A notch is defined along the longitudinal length of the second block opposite the concave surface. The notch is dimensioned to receive a longitudinal length of a second segment of the fishing rod. A strap slot is defined through a transverse dimension of each of the first block and the second block.

In some embodiments, the fishing rod holder also includes a strap having a first free end and a second end. The strap is formed of a hook material applied to a front surface and a loop material applied to a back surface of the strap. The strap has a transverse dimension to be received through the strap slot. The strap has a longitudinal length sufficient to at least extend through the strap slot, a first wrap around a first end of one of the first block or the second block having the concave surface and overlap at least a portion of the second end and the elongate shaft when received in the concave surface of one of the first block or the second block.

In some embodiments, the strap is sufficient to wrap around the side opposite the concave surface, the fishing rod when received in the V notch, and overlap at least a portion of the first wrap.

In other embodiments, a separation between the concave surface of the second block and the notch of the second block is less than a separation between the concave surface of the first block and the notch of the first block.

In yet other embodiments, a width and a depth of the notch of the second block is greater than a width and a depth of the notch of the first block.

These and other features, aspects and advantages of the present invention will become better understood with reference to the following drawings, description and claims.

### BRIEF DESCRIPTION OF THE DRAWINGS

FIG. 1 is a perspective view of the rod holder, shown in use;

FIG. 2 is a perspective view of the rod holder, shown in use holding a fishing rod 52;

FIG. 3 is a perspective view of the rod holder components;

FIG. 4 is an exploded view of the rod holder;

FIG. 5 is a detail perspective view of the rod holder, illustrating installation on paddle 50;

FIG. 6 is a detail perspective view of the rod holder, showing straps 30 in the standby position;

FIG. 7 is a section view of the rod holder, taken along line 7-7 in FIG. 2; and

FIG. 8 is a section view of the rod holder, taken along line 8-8 in FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention. Broadly, embodiments of the present invention provide a method and apparatus for removably and non-destructively securing a fishing rod to a paddle or push-pole for a self-propelled watercraft.

As stated above, to operate a self-propelled watercraft such as a Stand-Up paddleboard (SUP), kayak, canoe, rowboat, push boat or similar, using a paddle or push-pole typically requires the use of both hands. These self-propelled watercraft have limited space and mobility onboard and are greatly influenced by environmental conditions such as wind, waves and current. These circumstances cause several problems.

As seen in reference to the drawings of FIG. 1, a fishing rod holder according to aspects of the present invention is positioned on the shaft of a paddle 50 or push-pole 50 and utilizes a non-destructive method of attachment. The fishing rod holder will secure the fishing rod 52 from falling overboard, while allowing both hands to be free to operate the watercraft 56 with the paddle 50 or push-pole 50. If the paddle 50 or push-pole 50 is dropped in the water while operating the watercraft 56, the holder is configured so that the paddle 50 or push pole 50 will float with the fishing rod 52 attached to enable easy retrieval.

Having the fishing rod 52 positioned on the paddle 50 or push-pole 50 allows for good accessibility while standing, requiring negligible space and movement onboard the watercraft 56, as well as reducing the time to switch between fishing and padding mode allowing the operator to quickly regain position and heading control of the water craft 56.

Using a non-destructive and reusable method of attachment without the use of adhesives or hardware that could damage the watercraft 56, paddle 50 or push-pole 50 enables the fishing rod holder to be installed, adjusted or re-positioned without the use of tools and or special know-how. The fishing rod holder is compact and portable for easy transport and is independent of both the type of watercraft 56 and the paddle 50 or push-pole 50 used to propel the watercraft 56.

Aspects of the present invention provide the self-propelled watercraft angler a non-destructive, relocatable method of attachment of a fishing pole 52 to a watercraft paddle 50. While described in connection with use for a fishing pole 52, the holder of the present invention could also be used for attaching any piece of equipment, tool or sports equipment to an elongate cylindrical object.

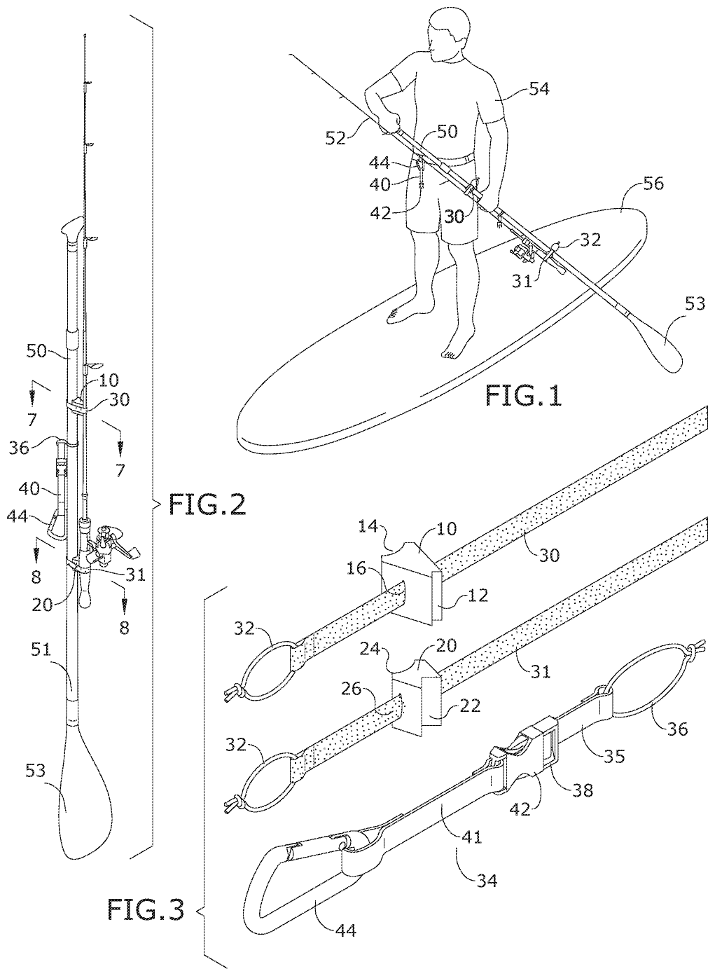

Other aspects of the present invention may be seen in reference to the drawings of FIGS. 2-8, the fishing rod holder of the invention may include the following components and features:

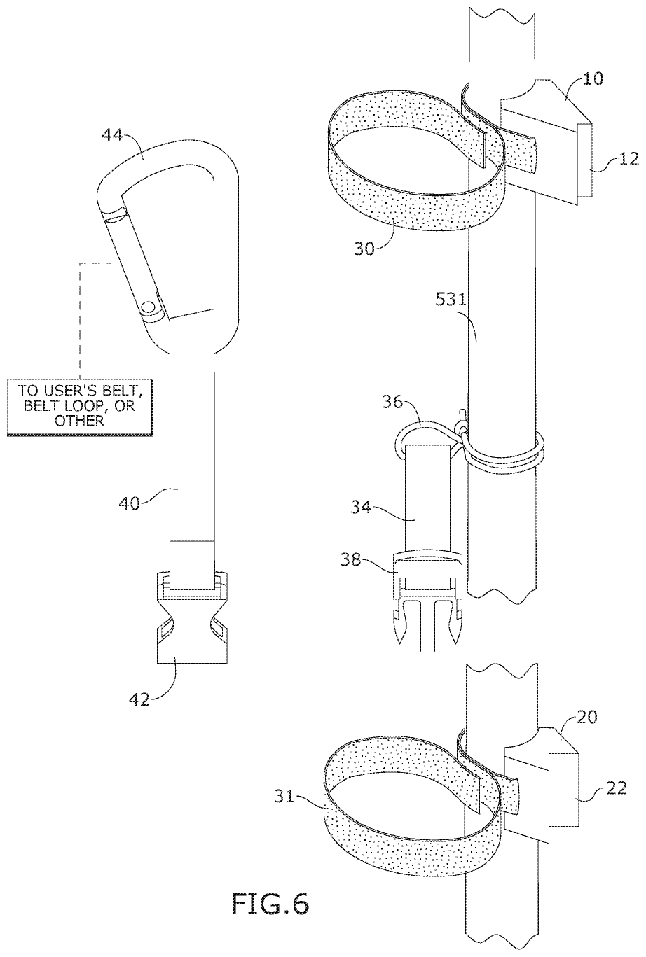

As best seen in reference to FIG. 3, Upper Holder: The upper holder 10 may be formed as a nine (9) sided block with seven (7) vertical and two (2) horizontal surfaces and is symmetric about its Z Axis (Centerline). The upper holder 10 may be fabricated using two (2) part molded silicone or similar plastic, rubber, or resilient material. Preferably, the upper holder 10 is formed as a buoyant body. The upper holder 10 has the same general configuration as a lower holder 20, but different in size and proportion, as illustrated in FIGS. 6, 7 and 8. Throughout the drawings, X is the Longitudinal, Y is the Transverse, and Z is the Depth orientation used to describe the configurations.

Lower Holder: The lower holder 20 may also be formed as a nine (9) sided block with seven (7) vertical and two (2) horizontal surfaces and is symmetric about its Z Axis (Centerline). The lower holder 20 is fabricated using two (2) part molded silicone or similar plastic, rubber or resilient material. Preferably, the lower holder is formed as a buoyant body. The lower holder 20 has the same general configuration as the upper holder 10 but is different in size and proportion, as illustrated in FIGS. 5 and 6. X is the Longitudinal, Y is the Transverse, Z is Depth orientations used to describe the configurations.

Upper Strap: An upper strap 30 is made from double sided hook and loop material (Velcro® or similar), preferably ¾ inch vertical and 18 inches long, the length may vary depending on the size of the fishing rod 52. The upper strap 30 has a first free end and a loop 32 disposed at a second end thereof.

Lower Strap: A lower strap 31 may also made from double sided hook and loop material (Velcro® or similar), again, preferably ¾ inch vertical and 18 inches long, the length may also vary depending on the size of the fishing rod 52. The lower strap 31 has a first free end and a loop 32 disposed at a second end thereof.

Upper V Notch: The upper V notch 12 is an element of the upper holder 10 and is positioned at a forward end of the upper holder 10 and defined along the X Axis. The upper V notch 12 is dimensioned to receive at least a portion of the fishing rod 52 shaft along a longitudinal length of the upper V notch 12.

Upper Strap Slot: The upper strap slot 16 is an element of the upper holder 10, it is a hole or void that extends transversely (Along the Y Axis) penetrating through two (2) of the vertical surfaces. The upper strap slot 16 is preferably centered about its depth and longitudinally along the Z and X Axis and may vary in dimension depending on the size and configuration of the upper strap 30.

Upper Concave Surface: The upper concave surface 14 is an element of the upper holder 10. It is one of the vertical surfaces positioned at the back end of the upper holder 10 along the X Axis. The upper concave surface 14 is dimensioned to receive at least a portion of the paddle shaft 51 along a longitudinal length of the upper concave surface 14.

Lower V Notch: The lower V notch 22 is an element of the lower holder 20 and is positioned at the forward end of the lower holder 20 along the X Axis. The lower V notch 22 is dimensioned to receive at least a portion of the fishing rod 52.

Lower Strap Slot: The lower strap slot 26 is an element of the lower holder 20. The lower strap slot 26 is a hole or void that extends transversely (Along the Y Axis) penetrating through two (2) of the vertical surfaces. The lower strap slot 26 is preferably centered about its depth and longitudinally along the Z and X Axis and may vary in dimension depending on the size and configuration of the lower strap 31.

Lower Concave Surface: The lower concave surface 24 is an element of the lower holder 20 and is one of the vertical surfaces positioned at the back end of the lower holder 20 along the X Axis. The lower concave surface 24 dimensioned to receive at least a portion of the paddle shaft 51.

Paddle: For the purpose of this application a paddle 50 will be used to demonstrate the invention but it could be substituted with a push pole or other propulsion device for a self-propelled watercraft. The paddle 50 may have a paddle Handle attached to a top end of an elongate paddle shaft 51 and a paddle blade 53. The paddle blade 53 may be aligned with or disposed at an angle relative a longitudinal axis of the elongate paddle shaft 51. A paddle Handle is sometimes an element of the paddle 50 positioned at the top end of the paddle shaft 51. In a kayak paddle 50, the paddle blades 53 are disposed at opposite ends of the paddle shaft 51.

Fishing Rod: For the purpose of this application a fishing rod 52 will be used to demonstrate the invention but it could be substituted with another piece of sports equipment or tool. The fishing rod 52 includes an elongate rod, having a plurality of ferrules aligned along a longitudinal length of the fishing rod pole. A fishing rod handle is disposed at proximal end of the fishing rod and a fishing rod reel is attached to the fishing rod handle.

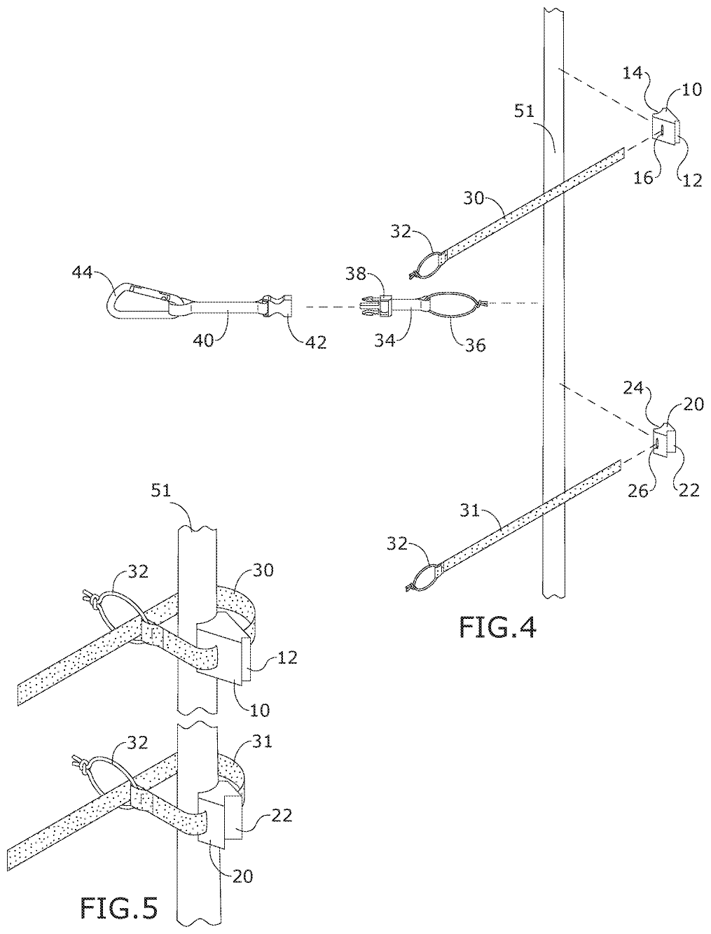

Having described the elements of the rod holder, the attachment to the paddle 50 and fishing rod 52 will be described. The upper holder 10 is positioned on the paddle shaft 51 approximately ¼ (0.25) of the paddle length down from the paddle handle along the X axis. The X-Axis of the upper holder 10 is aligned with the X-Axis and perpendicular to the Z-Axis of the paddle 50 with the upper V notch 12 facing away from the paddle shaft 51 in the forward direction with the upper concave surface 14 positioned in contact with the paddle shaft 51 as illustrated in FIGS. 4-6.

The lower holder 20 is likewise positioned on the paddle shaft 51 approximately ½ (0.5) of the paddle length down from the paddle handle along the X axis. The X-Axis of the lower holder 20 is aligned with the X-Axis and perpendicular to the Z-Axis of the paddle 50 with the lower V notch 22 facing away from the paddle shaft 51 in the forward direction and with the lower concave surface 24 in contact with the paddle shaft 51.

Preferably, the upper holder 10 has a greater length in the Z direction to allow sufficient space between the paddle shaft 51 and the fishing rod pole 52 for the paddler to grip around the paddle shaft 51 in the space between the fishing rod pole 52 and the paddle shaft 51. As shown in FIGS. 2, 7, and 8, when fully assembled, the fishing rod pole 52 is seated in the upper V notch 12 of the upper holder 10 and fishing rod handle is seated in the lower V notch 22 of the lower holder 20. The diameters of the Fishing rod pole 52 and fishing rod handle are different, so preferably, the V Notches 12 and 22 may have different dimensions as well.

A method of using the fishing rod holder may include the following steps:

Step 1: Securing the upper holder to the paddle. As Illustrated in FIGS. 4-6, the upper concave surface 14 of the upper holder 10 is placed in abutment against paddle shaft 51, where the X-Axis of the upper holder 10 is aligned with the X-Axis and perpendicular to the Z-Axis of the paddle 50 with the upper V notch 12 facing in a forward direction of the paddle 50, when held. The first free end of the upper strap 30 is routed through the upper strap slot 16 in the upper holder 10, wrapping around the paddle shaft 51 past the second free end and doubling back upon itself allowing the opposite face of the hook and loop material to attach and secure the upper holder 10 to the paddle 50.

Step 2: Securing the lower holder 20 to the paddle. As Illustrated in FIGS. 4 and 5, the lower concave surface 24 of the lower holder 20 is placed against paddle shaft 51, where the X-Axis of the lower holder 20 is aligned with the X-Axis and perpendicular to the Z-Axis of the paddle 50 with the lower V notch 22 facing in the forward direction of the paddle 50, as seen in reference FIG. 5. A first free end of the lower strap 31 is threaded through the lower strap slot 26 in the lower holder 20, wrapping around the paddle shaft 51 past the second free end and doubling back upon itself, allowing the opposite face of the hook and loop material to attach and securing the lower holder 20 to the paddle 50.

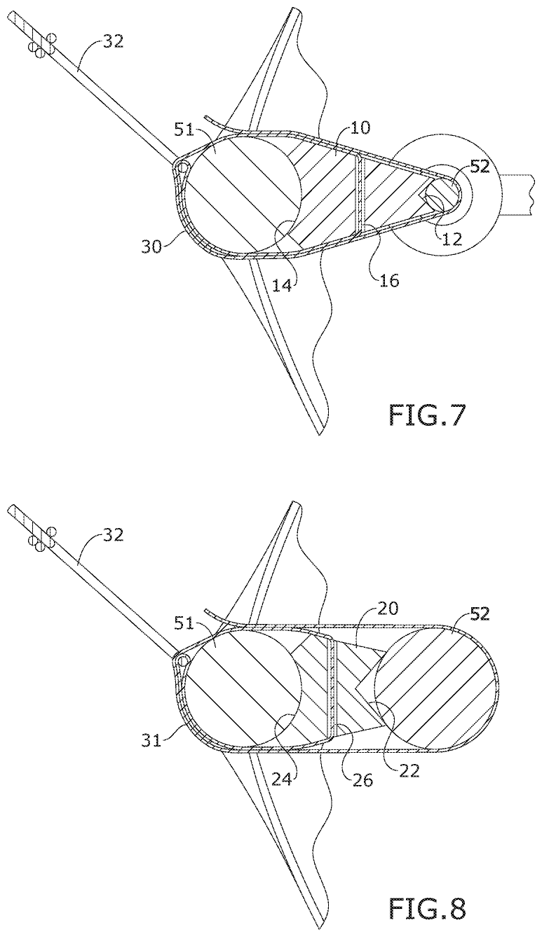

Step 3: Securing the fishing rod pole 51 to the holder. As Illustrated in FIGS. 2 and 7, the fishing rod pole 52 is seated into the upper V notch 12 of the upper holder 10. The upper strap 30 then continues to wrap the first free end around the fishing rod pole 52, doubling back upon itself again allowing the opposite faces of the hook and loop material to attach and secure the fishing rod 52 to the upper holder 10.

Step 4: Securing the fishing rod handle to the holder. As Illustrated in FIGS. 2 and 8, the fishing rod handle is seated into the lower V notch 22 of the lower holder 20. A first free end of the lower strap 31 then continues to wrap around the fishing rod 52 doubling back upon itself again allowing the opposite faces of the hook and loop material to attach and securing the fishing rod 52 to the lower holder 20.

To use the fishing rod holder of the present invention, attach the upper holder 10 and lower holder 20 using the upper strap 30 and lower strap 31, respectfully, as described above in Steps 1 and 2, the invention is now attached with the fishing rod 52 free and available for use.

To assemble the invention for paddling mode attach the fishing rod 52 using the upper strap 30 and lower strap 31 as described above in Steps 3 and 4 securing the fishing rod 52. When the paddler reaches the desired fishing location, the paddler can switch from paddling to fishing mode by reversing Steps 3 and 4 to release the fishing rod 52 from the paddle 50.

When switching between fishing to paddling mode or vice versa with the fishing rod 52 seated in the V Notches 12 and 22 of the upper and lower holder 10 and 20, the operator can wrap one hand around both the paddle shaft 51 and fishing rod pole 52 about ½ (0.5) way between the upper 10 and lower holder 20 and to apply slight pressure to ensure the fishing rod 52 is firmly held in position, then using the opposite hand to complete or reverse Steps 3 and 4.

Depending on the size and type of the fishing rod 52 only one (1) holder and one (1) strap 30 would be sufficient to keep the fishing rod 52 securely fastened to the paddle 50. The lower holder 20 and the lower strap 31 alone could be used to secure the fishing rod 52 to the paddle 50 making the upper holder 10 and the upper strap 30 optional. The upper holder 10 and lower holder 20 could also be attached to any cylindrical object and used to secure the fishing rod 52 onboard, making the paddle 50 optional.

The holder of the present invention works better by having the ability to secure the paddle 50 from falling overboard while standing in fishing mode, as well as the ability to regain access or retrieve the paddle 50 while standing in fishing mode. Both these abilities would reduce the required movement onboard the watercraft improving stability. Accordingly, a tether strap 34, best seen in reference to FIG. 3, may attach the paddle 50 to the user or to the watercraft 56. The tether strap includes a short strap 35 having a tether loop 36 attached at a first end thereof. A releasable coupler 38 is affixed to a second end thereof. A long strap element 41 has a coupler 42 that is configured to interconnect with the releasable coupler 38. A carabiner 44 of other releasable link is provided at an opposite end of the long strap 41. The tether loop 36 may be secured around the paddle shaft 51, as best seen in reference to FIG. 6. The carabiner 44 is releasably attached to a belt or belt loop of the user 54.

The ability to secure and access the paddle 50 while standing in fishing mode would further reduce the time to switch between fishing and paddling mode or vice versa allowing the operator to more quickly regain position and heading control of the watercraft. The paddle 50 could be attached to a belt, belt loop or strap positioned around the operator's waist. The tether loop 36 provides an attachment point of paddle 50 to the belt or tether strap should be positioned around the middle of the paddle shaft 51 this would enable the operator to maneuver the watercraft with one (1) hand by using the attachment to the belt or tether strap 34 as a pivot point similar to an oarlock. This would allow the operator to regain position and heading control of the watercraft without the need to switch between fishing and paddling mode.

In some embodiments, the lower holder 20 could be a tube shaped receptacle or cup, therefore only requiring the use of only one (1) strap, the upper strap 30 further decreasing the time to switch from paddling to fishing mode and vice versa, therefore simplifying Step 4.

In some embodiments, the upper holder 10 and lower holder 20 could use a magnet therefore eliminating the use of straps further decreasing the time to switch from paddling to fishing mode and vice versa.

When fully assembled, the upper strap 30 and lower straps 31 are wrapped around the fishing rod 52 securing it from falling overboard. Positioning the fishing rod 52 on the paddle 50 allows the paddler to have immediate access to the fishing rod 52 and limits the movement onboard the watercraft 56 thus maintaining its stability. Securing the paddle 50 to a belt or strap around the operation's waist with the tether strap will allow for timely switching between fishing and paddling mode or vice versa.

The upper holder 10 and lower holder 20 may be attached to the paddle shaft 51 with the upper strap 30 and lower strap 31 and held in place with the friction between the concave surfaces 12 and 22 and the paddle shaft 51. This non-destructive method of attachment causes no damage to the paddle 50 or watercraft 56, as well as allowing for adjustment or relocation of the fishing rod holder without the use of tools and or special know-how. Its compact design and ability to be transferred between various types of watercraft, fishing rods or paddles, enable this invention to be easily transported.

Also, the fishing rod holder of the present invention provides a non-destructive, relocatable method of attachment that could be used for attaching any piece of equipment, tool or sports equipment to a cylindrical object.

It should be understood, of course, that the foregoing relates to exemplary embodiments of the invention and that modifications may be made without departing from the spirit and scope of the invention as set forth herein.

What is claimed is:

1. A rod holder for securing a rod to an elongate shaft, comprising:
a holding block having a concave surface defined along a longitudinal length of the first holding block and a V shaped notch defined along the longitudinal length of the holding block along a side opposite the concave surface, the concave surface dimensioned to receive at least a portion of the elongate shaft and the V shaped notch dimensioned to receive at least a portion of the rod;
a strap slot define transversely through the holding block between the concave surface and the V shaped notch; and
a strap having a first free end and a second end, the strap formed of a cooperating hook and loop material applied to a front surface and a back surface of the strap, the strap having a transverse dimension to be received through the strap slot and a longitudinal length sufficient to at least extend through the strap slot, a first wrap around a first end of the holding block having the concave surface and overlap at least a portion of the second end and the elongate shaft when received in the concave surface.

2. The rod holder of claim 1, wherein the longitudinal length of the strap is sufficient to wrap around the side opposite the concave surface, the rod when received in the V shaped notch, and overlap at least a portion of the first wrap.

3. The rod holder of claim 2, further comprising:
a strap loop attached to the second end of the strap, the strap loop dimensioned to receive the strap through the strap loop in the first wrap.

4. The rod holder of claim 1, further comprising:
a second holding block having a concave surface defined along a longitudinal length of the second holding block and a V shaped notch defined along the longitudinal length of the second holding block along a side opposite the concave surface, the concave surface dimensioned to receive at least a portion of the elongate shaft and the V shaped notch dimensioned to receive at least a portion of the rod;
a second strap slot define transversely through the second holding block between the concave surface and the V shaped notch; and
a second strap having a first free end and a second end, the second strap formed of a cooperating hook and loop material applied to a front surface and a back surface of the second strap, the second strap having a transverse dimension to be received through the second strap slot and a longitudinal length sufficient to at least extend through the second strap slot, a first wrap around a first end of the second holding block having the concave surface and overlap at least a portion of the second end of the second strap and the elongate shaft when received in the concave surface of the second holding block.

5. The rod holder of claim 4, wherein the longitudinal length of the second strap is sufficient to wrap around the side opposite the concave surface of the second block, the rod when received in the V shaped notch of the second block, and overlap at least a portion of the first wrap about the second holding block.

6. The rod holder of claim 5, further comprising:
a strap loop attached to the second end of the second strap, the strap loop dimensioned to receive the second strap through the strap loop when the strap on the first wrap about the second holding block.

7. The rod holder of claim 4, wherein a separation between the concave surface of the second holding block and the V shaped notch of the second holding block is less a separation between the concave surface of the first holding block and the V shaped notch of the first holding block.

8. The rod holder of claim 4, wherein a width and a depth of the V shaped notch of the second holding block is greater than a width and a depth of the V shaped notch of the first holding block.

9. A fishing rod holder for securing the fishing rod to an elongate shaft of a paddle for a watercraft, comprising:
a first block having a concave surface defined along a longitudinal length of the first block, the concave surface dimensioned to abut a longitudinal length of the elongate shaft, and a notch defined along the longitudinal length of the first block opposite the concave surface, the notch dimensioned to receive a longitudinal length at a first segment of the fishing rod;
a second block having a concave surface defined along a longitudinal length of the second block, the concave surface dimensioned to abut a longitudinal length of the elongate shaft, and a notch defined along the longitudinal length of the second block opposite the concave surface, the notch dimensioned to receive a longitudinal length of a second segment of the fishing rod; and
a strap slot defined through a transverse dimension of each of the first block and the second block.

10. The fishing rod holder of claim 9, further comprising:
a strap having a first free end and a second end, the strap formed of a hook material applied to a front surface and a loop material applied to a back surface of the strap, the strap having a transverse dimension to be received through the strap slot and a longitudinal length sufficient to at least extend through the strap slot, a first wrap around a first end of one of the first block or the second block having the concave surface and overlap at least a portion of the second end and the elongate shaft when received in the concave surface of one of the first block or the second block.

11. The fishing rod holder of claim 10, wherein the longitudinal length of the strap is sufficient to wrap around the side opposite the concave surface, the fishing rod when received in the notch, and overlap at least a portion of the first wrap.

12. The fishing rod holder of claim 11, wherein a separation between the concave surface of the second block and the notch of the second holding block is less than a separation between the concave surface of the first block and the notch of the first block.

13. The rod holder of claim 11 wherein a width and a depth of the notch of the second block is greater than a width and a depth of the notch of the first block.

14. The rod holder of claim 11, wherein the first block and the second block are formed of a buoyant material.
